(19) United States
(12) Patent Application Publication
(10) Pub. No.: US 2024/0176059 A1
(43) Pub. Date: May 30, 2024

(54) LIGHT GUIDE PLATE STRUCTURE AND BACKLIGHT MODULE

(71) Applicant: DARWIN PRECISIONS CORPORATION, Hsinchu County (TW)

(72) Inventors: CHIEN-MING CHU, Hsinchu County (TW); YA-FANG HUANG, Hsinchu County (TW); HUA-YING CHUANG, Hsinchu County (TW)

(21) Appl. No.: 18/230,192

(22) Filed: Aug. 4, 2023

(30) Foreign Application Priority Data
Nov. 25, 2022 (TW) 111145124

(51) Int. Cl. F21V 8/00

(52) U.S. Cl. CPC G02B 6/0043; G02B 6/0058

(57) ABSTRACT

A light guide plate structure includes a body and a plurality of microstructures. The body includes a first surface, a second surface, and a light incident surface. The light incident surface is connected to the first surface and the second surface. The light incident surface faces a light source, and light incident by the light source via the light incident surface has a light source direction on the body. The microstructures are formed on the first surface and have crests and troughs along a second direction, where projections of the crests on the first surface are distributed on a plurality of first wave trajectories, each of the first wave trajectories extends along the light source direction, and the troughs have ups and downs in the first direction. The light guide plate structure may improve the optical grade of pictures of a display device. A backlight module is also provided.

### FIELD OF THE INVENTION

The present invention relates to a light guide plate structure, and more particularly to a light guide plate structure within a backlight module capable of improving the optical grade of pictures of a display device and maintaining the brightness of the display device.

### BACKGROUND OF THE INVENTION

In general, a liquid crystal display device includes a liquid crystal display panel and a backlight module. Since the liquid crystal display panel does not emit light, the backlight module is needed to provide a lighting source to the liquid crystal display panel. Therefore, the backlight module mainly functions to provide the high-brightness and high-uniformity lighting source. Generally, the backlight module includes a light source, a light guide plate, a diffusion sheet, and a light collecting sheet. Light of the light source is incident on the light guide plate from a side surface, the diffusion sheet homogenizes light emitted by the light guide plate, and the light collecting sheet is configured to improve the light brightness of the display panel.

However, regularly arranged semi-cylindrical prisms are provided on the light collecting sheet in general, so that interference fringes are easily generated together with the display panel. Usually, the light collecting sheet will be rotated to improve the problem of interference fringes. However, after the light collecting sheet is rotated, the brightness and efficiency will decrease. In addition, regularly arranged semi-cylindrical prisms will also be formed on some light guide plates, so that obvious cross interference fringes will also be caused between the light guide plate and the light collecting sheet to affect display pictures.

### SUMMARY OF THE INVENTION

The present invention provides a light guide plate structure and a backlight module, wherein the light guide plate structure may improve the optical grade of pictures of a display device and maintains the brightness of the display device.

The light guide plate structure provided by the present invention includes a body and a plurality of microstructures. The body includes a first surface, a second surface, and a light incident surface. The second surface is opposite to the first surface along a first direction. The light incident surface is connected to the first surface and the second surface. The light incident surface is adapted to face a light source, and light incident by the light source via the light incident surface has a light source direction on the body. The plurality of microstructures are formed on the first surface and have a plurality of crests and a plurality of troughs along a second direction, where projections of the crests on the first surface are distributed on a plurality of first wave trajectories, each of the first wave trajectories extends along the light source direction, and the troughs have ups and downs in the first direction.

In an embodiment of the present invention, the above first direction is a Z direction of a rectangular coordinate system, the second direction is an X direction of the rectangular coordinate system, the light source direction is a Y direction of the rectangular coordinate system, the Y direction and the Z direction constitute a Y-Z plane, and the Y direction and the X direction constitute an X-Y plane.

In an embodiment of the present invention, any adjacent two of the first wave trajectories in the above X direction are configured in a mirror symmetry manner.

In an embodiment of the present invention, projections of the above crests on the Y-Z plane have a height change in the Z direction.

In an embodiment of the present invention, projections of the above crests on the Y-Z plane along the Y direction are distributed on a second wave trajectory.

In an embodiment of the present invention, projections of the above troughs on the Y-Z plane have a height change in the Z direction.

In an embodiment of the present invention, projections of the above troughs on an X-Z plane have a height change in the Z direction.

In an embodiment of the present invention, a depth of the above troughs ranges from 3 microns to 80 microns.

In an embodiment of the present invention, a first slope surface and a second slope surface are provided between the adjacent two of the crests and one of the troughs that is between the two adjacent crests, respectively, a first angle is formed between the first slope surface and the second slope surface, a second angle is formed between a connecting line between the two adjacent crests and the first slope surface, and a third angle is formed between the connecting line between the two adjacent crests and the second slope surface.

In an embodiment of the present invention, the above first angle is between 90° and 140°.

In an embodiment of the present invention, the above second angle is between 10° and 80°.

In an embodiment of the present invention, the above third angle is between 10° and 80°.

In an embodiment of the present invention, the above second angle is not equal to the third angle.

In an embodiment of the present invention, the above second angle is equal to the third angle.

The backlight module provided by the present invention includes a light source, the above light guide plate structure, and a light collecting sheet set. The light collecting sheet set is arranged on one side of the light guide plate structure, and the plurality of microstructures of the light guide plate structure face the light collecting sheet set.

In an embodiment of the present invention, the above light collecting sheet set includes at least one prismatic lens.

In an embodiment of the present invention, the backlight module further comprises two diffusion sheets arranged on two opposite sides of the light collecting sheet set, respectively, wherein one of the diffusion sheets is arranged between the light guide plate structure and the light collecting sheet set.

In an embodiment of the present invention, the backlight module is suitable for applying to a display device comprising a display panel, wherein the other one of the diffusion sheets is arranged between the display panel and the light collecting sheet set.

In an embodiment of the present invention, the backlight module further comprises at least one diffusion sheet arranged between the light guide plate structure and the light collecting sheet set.

In an embodiment of the present invention, the backlight module is suitable for applying to a display device comprising a display panel, wherein the light collecting sheet set is arranged between the at least one diffusion sheet and the display panel.

The backlight module provided by the present invention includes a light source, the above light guide plate structure, at least one diffusion sheet, and a dual brightness enhancement film. The at least one diffusion sheet is arranged on one side of the light guide plate structure, wherein the plurality of microstructures face the at least one diffusion sheet. The dual brightness enhancement film is arranged on one side of the at least one diffusion sheet, wherein the at least one diffusion sheet is between the dual brightness enhancement film and the light guide plate structure.

In an embodiment of the present invention, the backlight module is suitable for applying to a display device comprising a display panel, wherein the dual brightness enhancement film is arranged between the at least one diffusion sheet and the display panel.

In an embodiment of the present invention, the dual brightness enhancement film is the dual brightness enhancement film-diffusion (DBEF-D).

In the present invention, the microstructures are formed on a light emitting surface of the light guide plate structure, and the microstructures are V-shaped wave structures and undulate in the X, Y, and Z directions to present unfixed pitches and depths, where the unfixed pitches and depths presented along the X and Z directions can more effectively disturb the light directivity, so that the light incident by the light source presents an atomization effect on a light guide plate and an angle of view is adjusted. Therefore, the light guide plate structure can be applicable to display panels with different specifications of pixel pitches and light collecting sheet with different specifications of structure pitches in the industry, so as to improve the optical grade of pictures of the display device and maintain the brightness of the display device, thus achieving the specification consistency of light guide plate products, and making it have the advantage of reducing costs.

### BRIEF DESCRIPTION OF THE DRAWINGS

The present invention will become more readily apparent to those ordinarily skilled in the art after reviewing the following detailed description and accompanying drawings, in which:

FIG. 1 is a schematic structural diagram of a light guide plate structure according to an embodiment of the present invention;

FIG. 2 is a schematic configuration diagram of a light guide plate structure and a light source according to an embodiment of the present invention;

FIG. 3 is a schematic top view of FIG. 1;

FIG. 4 is a schematic sectional view of a line segment A-A shown in FIG. 3;

FIG. 5A is a schematic partial enlarged view of FIG. 3, and FIG. 5B is a schematic sectional view of a line segment BB shown in FIG. 5A;

FIG. 6A is another schematic partial enlarged view of FIG. 3, and FIG. 6B is a schematic sectional view of a line segment CC shown in FIG. 6A;

FIG. 7 is a schematic partial enlarged view of FIG. 1;

FIG. 8 is a schematic diagram of application of a light guide plate structure according to an embodiment of the present invention to a display device;

FIG. 9 is a schematic diagram of application of a light guide plate structure according to another embodiment of the present invention to a display device; and

FIG. 10 is a schematic diagram of application of a light guide plate structure according to another embodiment of the present invention to a display device.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

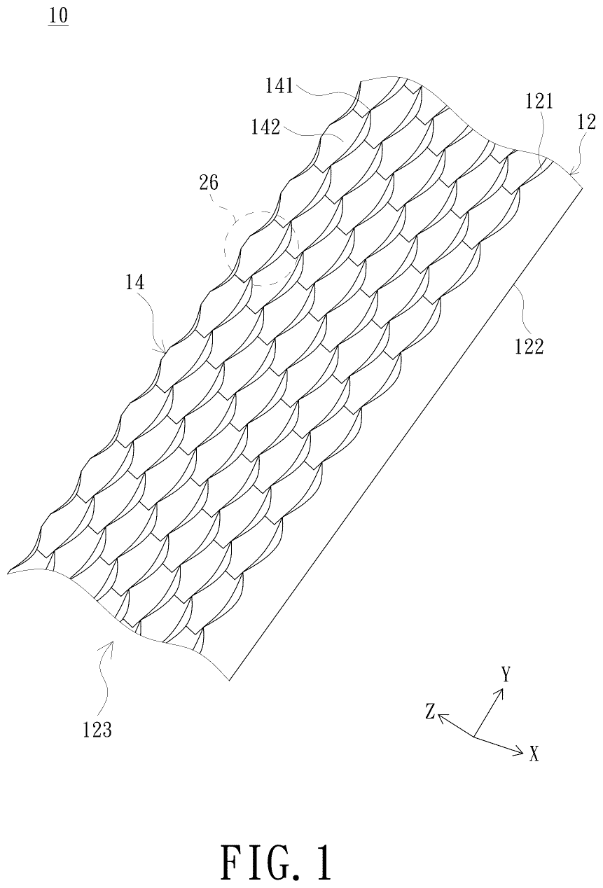

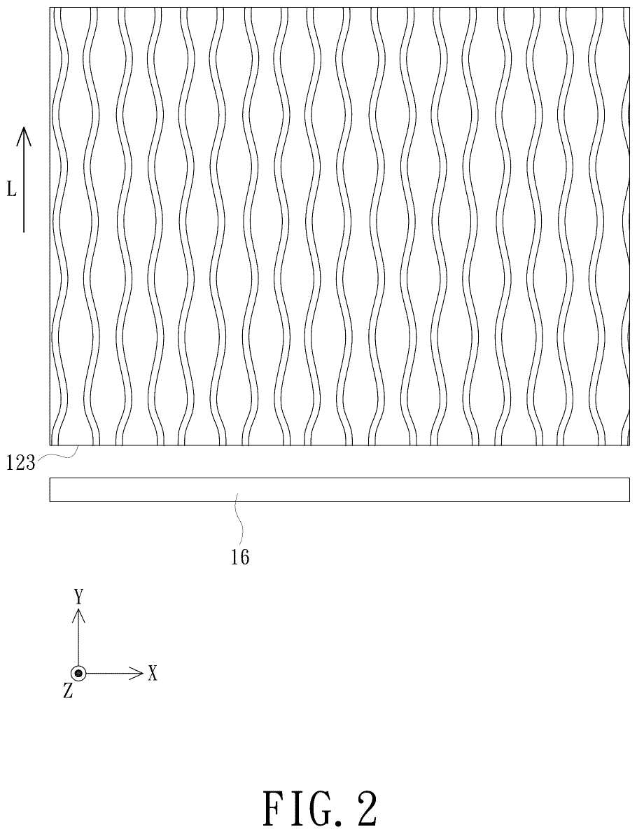

FIG. 1 is a schematic structural diagram of a light guide plate structure according to an embodiment of the present invention, and FIG. 2 is a schematic configuration diagram of a light guide plate structure and a light source according to an embodiment of the present invention. As shown in FIG. 1, the light guide plate structure 10 includes a body 12 and a plurality of microstructures 14 formed on the body 12. The body 12 includes a first surface 121, a second surface 122, and a light incident surface 123. The light incident surface 123 is connected to the first surface 121 and the second surface 122. To facilitate the description of the body 12 and the microstructures 14, a rectangular coordinate system is defined, including an X direction, a Y direction, and a Z direction that are perpendicular to one another. The X direction and the Y direction constitute an X-Y plane, the X direction and the Z direction constitute an X-Z plane, and the Y direction and the Z direction constitute a Y-Z plane, where the X-Y plane, for example, is substantially parallel to the first surface 121, the X-Z plane, for example, is substantially parallel to the light incident surface, and the second surface 122 is opposite to the first surface 121 along the Z direction (i.e., a first direction). As shown in FIG. 2, the light incident surface 123 of the body 12 is adapted to face a light source 16, and light incident by the light source 16 via the light incident surface 123 has a light source direction L on the body 12. The light source direction L is, for example, substantially parallel to the Y direction.

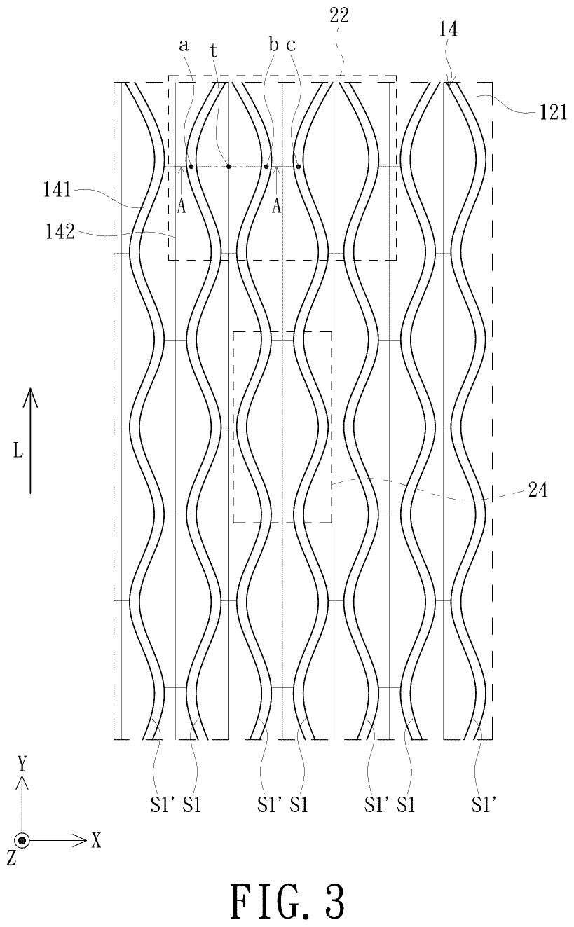

Continuing with the above description, as shown in FIG. 1, the microstructures 14 are distributed and formed on the first surface 121, and the microstructures 14 along the X direction (i.e., a second direction) have a plurality of crests 141 and a plurality of troughs 142. Referring to FIG. 3 that is a schematic top view of FIG. 1, projections of the plurality of crests 141 on the first surface 121 are distributed on a plurality of first wave trajectories S1 and S1′, and each first wave trajectory S1/S1′ extends along the light source direction L (i.e., the Y direction). In other words, the projections of the plurality of crests 141 on the X-Y plane along the Y direction are distributed on the first wave trajectories S1 and S1′. In an embodiment, any two adjacent first wave trajectories S1 and S1′ in the X direction (i.e., the second direction) are configured in a mirror symmetry manner.

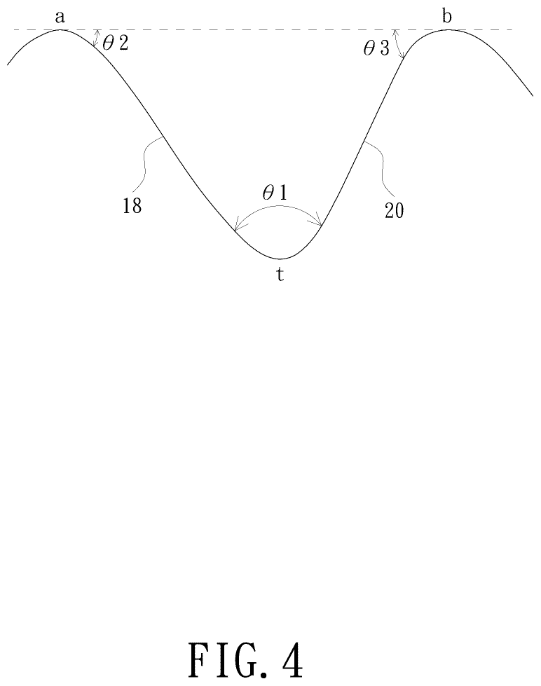

FIG. 4 is a schematic sectional view of a line segment AA shown in FIG. 3, where the line segment AA is, for example, along the X direction. As shown in FIG. 3 and FIG. 4, two adjacent crests (such as a crest a and a crest b) in the X direction form a slightly V shape with a trough (such as a trough t) between the two adjacent crests, a first slope surface 18 and a second slope surface 20 are provided between the two crests a and b and the trough t, respectively, a first angle θ1 is formed between the first slope surface 18 and the second slope surface 20, a second angle θ2 is formed between a connecting line between the two adjacent crests a and b and the first slope surface 18, and a third angle θ3 is formed between a connecting line between the two adjacent crests a and b and the second slope surface 20. In an embodiment, the first angle θ1 is between 90° and 140°, the second angle θ2 is between 10° and 80°, and the third angle θ3 is between 10° and 80°. The second angle θ2 may be equal to or not equal to the third angle θ3. In addition, a depth of the troughs 142 ranges from 3 microns to 80 microns, for example.

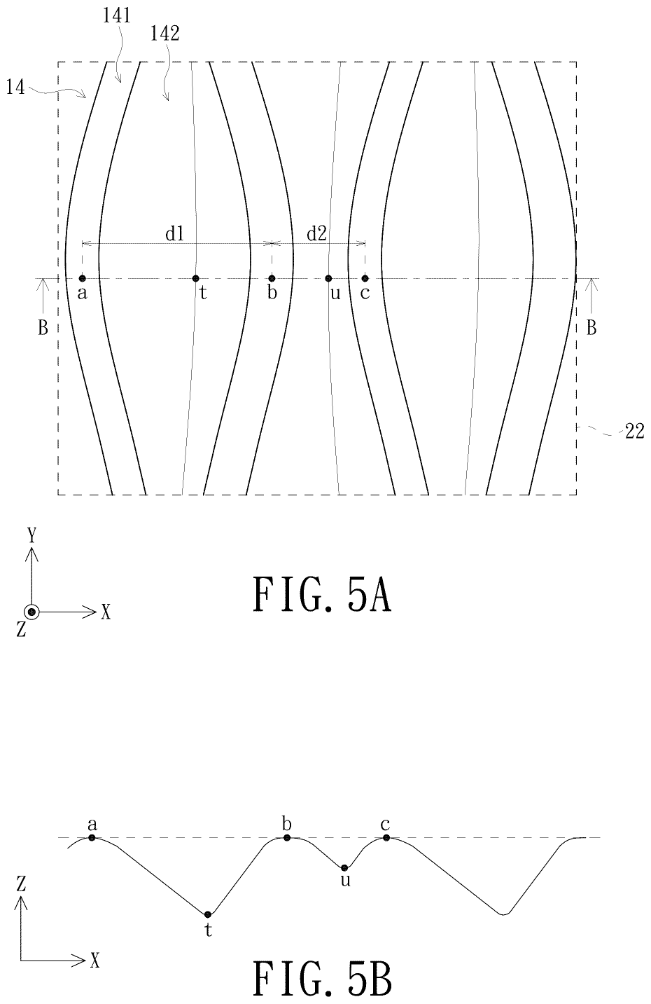

Continuing with the above description, the plurality of troughs 142 have ups and downs in the Z direction (i.e., the first direction). In an embodiment, projections of the troughs 142 on the X-Z plane have a height change in the Z direction. FIG. 5A is a schematic partial enlarged view of FIG. 3, and FIG. 5B is a schematic sectional view of a line segment BB shown in FIG. 5A, where FIG. 5A is, for example, a schematic enlarged view of a region 22 in FIG. 3, the line segment BB is, for example, along the X direction, and as shown in FIG. 5A and FIG. 5B, along the X direction, the microstructures 14 have the plurality of crests 141 and the plurality of troughs 142. In an embodiment, when the two adjacent crests (such as the crest a and the crest b) in the X direction have a longer distance d1, the trough t between the two crests a and b has a larger depth, and when two adjacent crests (such as the crest b and a crest c) in the X direction have a shorter distance d2, a trough u between the two crests b and c has a smaller depth.

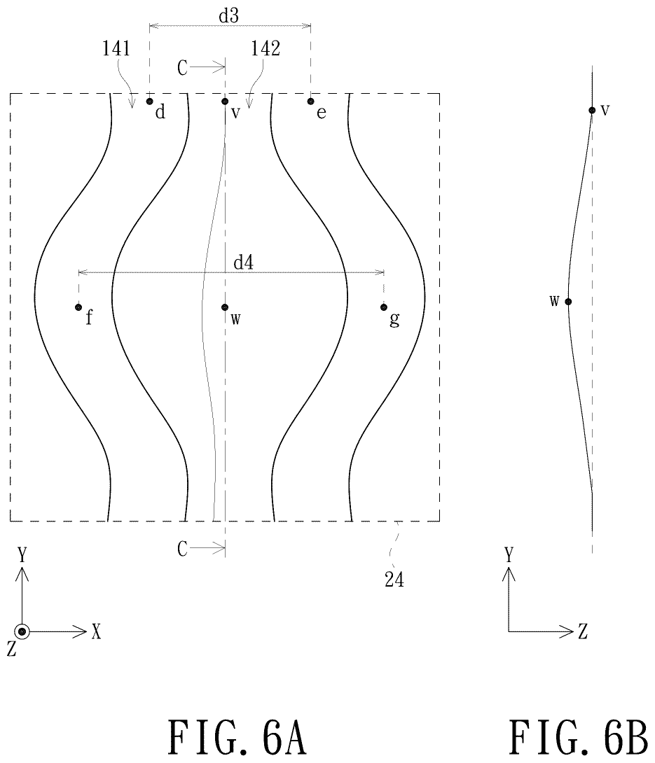

In addition, in an embodiment, projections of the plurality of troughs 142 on the Y-Z plane also have a height change in the Z direction. FIG. 6A is another schematic partial enlarged view of FIG. 3, and FIG. 6B is a schematic sectional view of a line segment CC shown in FIG. 6A, where FIG. 6A is, for example, a schematic enlarged view of a region 24 in FIG. 3, and the line segment CC is, for example, along the Y direction and passes through the plurality of troughs 142. In an embodiment, the troughs 142 still have wave-like ups and downs along the Y direction. As shown in FIG. 6A and FIG. 6B, when two adjacent crests 141 (such as a crest d and a crest e) in the X direction have a shorter distance d2, the position of a trough v between the two crests d and e is higher, and when two adjacent crests 141 (such as a crest f and a crest g) in the X direction have a longer distance d4, the position of a trough w between the two crests f and g is lower.

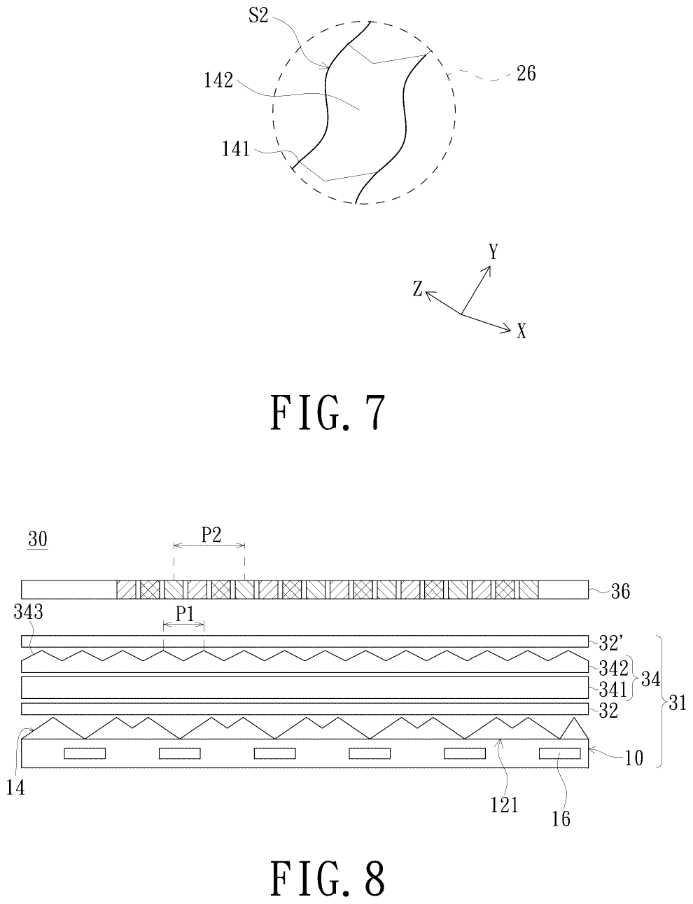

Continuing with the above description, in addition to that the projections of the plurality of crests 141 on the X-Y plane are distributed on the first wave trajectories S1 and S1′ as shown in FIG. 2, the projections of the crests 141 on the Y-Z plane also have a height change in the Z direction. FIG. 7 is a schematic partial enlarged view of FIG. 1. FIG. 7 is, for example, a schematic enlarged view of a region 26 in FIG. 1. As shown in the figure, projections of the crests 141 on the Y-Z plane along the Y direction are distributed on a second wave trajectory S2.

FIG. 8 is a schematic diagram of application of a light guide plate structure according to an embodiment of the present invention to a display device. As shown in the figure, the display device 30 includes a backlight module 31 and a display panel 36. The backlight module 31 is arranged on one side of the display panel 36 and the backlight module 31 includes a light source 16, a light guide plate structure 10, and a light collecting sheet set 34, wherein the light source 16 is arranged on one side of the light guide plate structure 10, and the light collecting sheet set 34 is arranged between the display panel 36 and the light guide plate structure 10. In one embodiment, the first surface 121 of the light guide plate structure 10 is, for example, the light emitting surface, and the microstructures 14 are arranged on the light emitting surface to face the light collecting sheet set 34. In one embodiment, the light collecting sheet set 34 includes, for example, two orthogonal prismatic lenses 341 and 342. A plurality of ribs 343 are provided on the prismatic lens 341/342. The first angle θ1 (marked in FIG. 4), the second angle θ2 (marked in FIG. 4), and the third angle θ3 (marked in FIG. 4) of the microstructures 14 may be adjusted according to different rotation angles of the light collecting sheet set 34. For example, a distance between two adjacent ribs 343 on the prismatic lens 341/342 is defined as a structure pitch p1; when both a pixel pitch p2 of the display panel 36 and the structure pitch p1 are of a regular arrangement structure, the second angle θ2 and the third angle θ3 of the microstructures 14 of the light guide plate structure 10 may be same, for example, both the second angle θ2 and the third angle θ3 are 40°, while the first angle θ1 is 100°; and when the light collecting sheet set 34 rotates an angle, that is, for example, 5°, relative to the display panel 36, the second angle θ2 and the third angle θ3 of the microstructures 14 may be different, for example, one of the second angle θ2 and the third angle θ3 are 50°, the other angle is 30°, while the first angle θ1 is 100°. In this way, in addition to that interference fringes generated between the light collecting sheet set 34 and the display panel 36 may be avoided by rotating the light collecting sheet set 34, the brightness and efficiency reduction caused by rotating the light collecting sheet set 34 may be avoided by means of asymmetric design of the second angle θ2 and the third angle θ3 of the microstructures 14 to effectively maintain the brightness of the display device 30.

In one embodiment, the backlight module 31 further includes two diffusion sheets 32, 32′. The diffusion sheet 32 is arranged between the light guide plate structure 10 and the light collecting sheet set 34, and the diffusion sheet 32′ is arranged between the display panel 36 and the light collecting sheet set 34. In one embodiment, the backlight module 31 is not limited to be used in a display device in combination with a display panel. The backlight module 31 can be used in any product that needs to have a backlight.

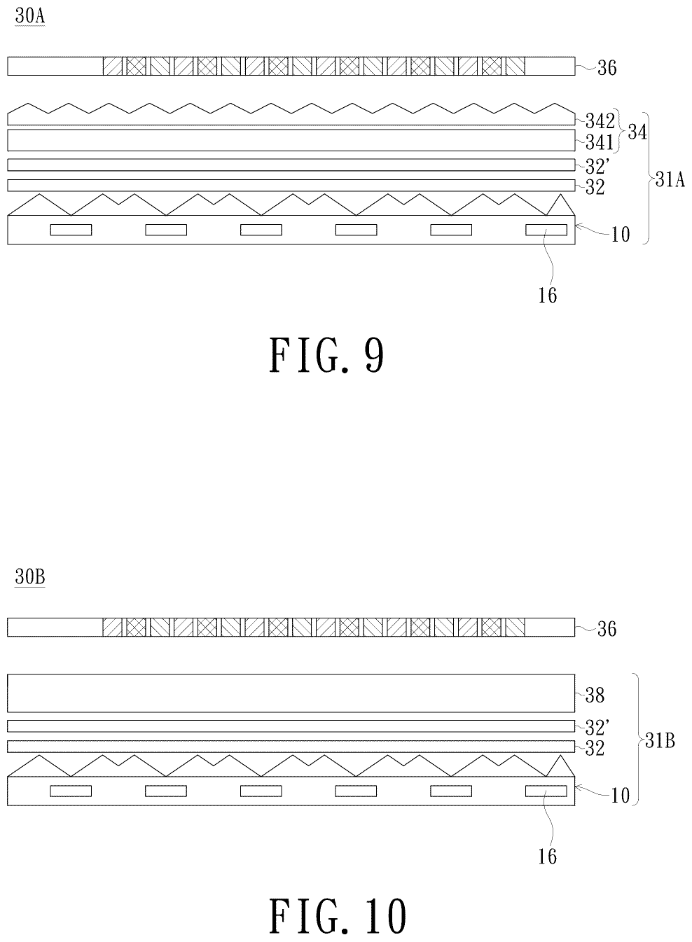

FIG. 9 is a schematic diagram of application of a light guide plate structure according to another embodiment of the present invention to a display device. As shown in the figure, the display device 30A includes a backlight module 31A and a display panel 36. The backlight module 31A is arranged on one side of the display panel 36 and the backlight module 31A includes a light source 16, a light guide plate structure 10, two diffusion sheets 32, 32′ and a light collecting sheet set 34. The light source 16 is arranged on one side of the light guide plate structure 10, the two diffusion sheets 32, 32′ are arranged on the light guide plate structure 10 and the light collecting sheet set 34 is arranged on the two diffusion sheets 32, 32′, wherein the two diffusion sheets 32, 32′ are arranged between the light guide plate structure 10 and the light collecting sheet set 34, and the light collecting sheet set 34 is arranged between one of the two diffusion sheets 32, 32′ and the display panel 36. In one embodiment, the backlight module 31A is not limited to be used in a display device in combination with a display panel. The backlight module 31A can be used in any product that needs to have a backlight. In one embodiment, it is not limited to use two diffusion sheets 32, 32′, and only single diffusion sheet can be used.

FIG. 10 is a schematic diagram of application of a light guide plate structure according to another embodiment of the present invention to a display device. As shown in the figure, the display device 30B includes a backlight module 31B and a display panel 36. The backlight module 31B is arranged on one side of the display panel 36 and the backlight module 31B includes a light source 16, a light guide plate structure 10, two diffusion sheets 32, 32′ and a dual brightness enhancement film (DBEF) 38. The light source 16 is arranged on one side of the light guide plate structure 10, the two diffusion sheets 32, 32′ are arranged on the light guide plate structure 10 and the dual brightness enhancement film 38 is arranged on the two diffusion sheets 32, 32′, wherein the two diffusion sheets 32, 32′ are arranged between the light guide plate structure 10 and the dual brightness enhancement film 38, and the dual brightness enhancement film 38 is arranged between one of the two diffusion sheets 32, 32′ and the display panel 36. In one embodiment, it is not limited to use two diffusion sheets 32, 32′, and only single diffusion sheet can be used. In on embodiment, the dual brightness enhancement film 38 is the dual brightness enhancement film-diffusion (DBEF-D). In one embodiment, the backlight module 31B is not limited to be used in a display device in combination with a display panel. The backlight module 31B can be used in any product that needs to have a backlight.

Based on the above, the plurality of crests, the plurality of troughs and the wave trajectories can change the light to exit the light guide plate in irregular directions to improve the interference phenomenon of display. In the light guide plate structure within a backlight module according to the embodiment of the present invention, the microstructures are V-shaped wave structures on the light emitting surface and undulate in the X, Y, and Z directions to present unfixed pitches and depths, where the unfixed pitches and depths presented along the X and Z directions can more effectively disturb the light directivity, so that the light incident by the light source presents an atomization effect on a light guide plate and an angle of view is adjusted. Therefore, the light guide plate structure according to the embodiment of the present invention can be applicable to display panels with different specifications of pixel pitches and light collecting sheet set with different specifications of structure pitches in the industry, so as to improve the optical grade of pictures of the display device and maintain the brightness of the display device, thus achieving the specification consistency of light guide plate products, and making it have the advantage of reducing costs.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light guide plate structure, comprising:
a body comprising a first surface, a second surface, and a light incident surface, wherein the second surface is opposite to the first surface along a first direction, the light incident surface is connected to the first surface and the second surface, the light incident surface is adapted to face a light source, and light incident by the light source via the light incident surface has a light source direction on the body; and
a plurality of microstructures being formed on the first surface and having a plurality of crests and a plurality of troughs along a second direction, wherein projections of the crests on the first surface are distributed on a plurality of first wave trajectories, each of the first wave trajectories extends along the light source direction, and the troughs have ups and downs in the first direction.

2. The light guide plate structure according to claim 1, wherein the first direction is a Z direction of a rectangular coordinate system, the second direction is an X direction of the rectangular coordinate system, the light source direction is a Y direction of the rectangular coordinate system, the Y direction and the Z direction constitute a Y-Z plane, and the Y direction and the X direction constitute an X-Y plane.

3. The light guide plate structure according to claim 2, wherein any adjacent two of the first wave trajectories in the X direction are configured in a mirror symmetry manner.

4. The light guide plate structure according to claim 2, wherein projections of the crests on the Y-Z plane have a height change in the Z direction.

5. The light guide plate structure according to claim 2, wherein projections of the crests on the Y-Z plane along the Y direction are distributed on a second wave trajectory.

6. The light guide plate structure according to claim 2, wherein projections of the troughs on the Y-Z plane have a height change in the Z direction.

7. The light guide plate structure according to claim 2, wherein projections of the troughs on an X-Z plane have a height change in the Z direction.

8. The light guide plate structure according to claim 1, wherein a depth of the troughs ranges from 3 microns to 80 microns.

9. The light guide plate structure according to claim 1, wherein a first slope surface and a second slope surface are provided between the adjacent two of the crests and one of the troughs that is between the two adjacent crests, respectively, a first angle is formed between the first slope surface and the second slope surface, a second angle is formed between a connecting line between the two adjacent crests and the first slope surface, and a third angle is formed between the connecting line between the two adjacent crests and the second slope surface.

10. The light guide plate structure according to claim 9, wherein the first angle is between 90° and 140°.

11. The light guide plate structure according to claim 9, wherein the second angle is between 10° and 80°.

12. The light guide plate structure according to claim 9, wherein the third angle is between 10° and 80°.

13. The light guide plate structure according to claim 9, wherein the second angle is not equal to the third angle.

14. The light guide plate structure according to claim 9, wherein the second angle is equal to the third angle.

15. A backlight module, comprising:
a light source;
a light guide plate structure, comprising:
a body comprising a first surface, a second surface, and a light incident surface, wherein the second surface is opposite to the first surface along a first direction, the light incident surface is connected to the first surface and the second surface, the light incident surface is adapted to face the light source, and light incident by the light source via the light incident surface has a light source direction on the body; and
a plurality of microstructures being formed on the first surface and having a plurality of crests and a plurality of troughs along a second direction, wherein projections of the crests on the first surface are distributed on a plurality of first wave trajectories, each of the first wave trajectories extends along the light source direction, and the troughs have ups and downs in the first direction; and
a light collecting sheet set, arranged on one side of the light guide plate structure, wherein the plurality of microstructures face the light collecting sheet set.

16. The backlight module according to claim 15, wherein the light collecting sheet set comprises at least one prismatic lens.

17. The backlight module according to claim 15, further comprising two diffusion sheets arranged on opposite sides of the light collecting sheet set, respectively, wherein one of the diffusion sheets is arranged between the light guide plate structure and the light collecting sheet set.

18. The backlight module according to claim 17, being suitable for applying to a display device comprising a display panel, wherein the other one of the diffusion sheets is arranged between the display panel and the light collecting sheet set.

19. The backlight module according to claim 15, further comprising at least one diffusion sheet arranged between the light guide plate structure and the light collecting sheet set.

20. The backlight module according to claim 19, being suitable for applying to a display device comprising a display panel, wherein the light collecting sheet set is arranged between the at least one diffusion sheet and the display panel.

21. A backlight module, comprising:
a light source;
a light guide plate structure, comprising:
a body comprising a first surface, a second surface, and a light incident surface, wherein the second surface is opposite to the first surface along a first direction, the light incident surface is connected to the first surface and the second surface, the light incident surface is adapted to face the light source, and light incident by the light source via the light incident surface has a light source direction on the body; and
a plurality of microstructures being formed on the first surface and having a plurality of crests and a plurality of troughs along a second direction, wherein projections of the crests on the first surface are distributed on a plurality of first wave trajectories, each of the first wave trajectories extends along the light source direction, and the troughs have ups and downs in the first direction;
at least one diffusion sheet, arranged on one side of the light guide plate structure, wherein the plurality of microstructures face the at least one diffusion sheet; and
a dual brightness enhancement film, arranged on one side of the at least one diffusion sheet, wherein the at least one diffusion sheet is between the dual brightness enhancement film and the light guide plate structure.

22. The backlight module according to claim 21, being suitable for applying to a display device comprising a display panel, wherein the dual brightness enhancement film is arranged between the at least one diffusion sheet and the display panel.

23. The backlight module according to claim 21, wherein the dual brightness enhancement film is the dual brightness enhancement film-diffusion (DBEF-D).
